(19) United States
(12) Patent Application Publication
(10) Pub. No.: US 2026/0301655 A1
(43) Pub. Date: Oct. 1, 2026

(54) PIXEL CIRCUIT, DRIVING METHOD AND DISPLAY DEVICE

(71) Applicants: Beijing BOE Technology Development Co., Ltd., Beijing (CN); BOE TECHNOLOGY GROUP CO., LTD., Beijing (CN)

(72) Inventors: Minghua Xuan, Beijing (CN); Jinfei Niu, Beijing (CN); Qi Qi, Beijing (CN)

(73) Assignees: Beijing BOE Technology Development Co., Ltd., Beijing (CN); BOE TECHNOLOGY GROUP CO., LTD., Beijing (CN)

(21) Appl. No.: 19/480,092

(22) PCT Filed: Apr. 17, 2024
(86) PCT No.: PCT/CN2024/088268

§ 371 Date: Oct. 30, 2025

(30) Foreign Application Priority Data
May 26, 2023 (CN) 202310610335.4

(51) Int. Cl. G09G 3/32

(52) U.S. Cl. CPC G09G 3/32; G09G 2300/043; G09G 2300/0819; G09G 2300/0842; G09G 2320/045

(57) ABSTRACT

A pixel circuit, a driving method and a display device are provided. The pixel circuit includes a light-emitting element, a driving circuit, a driving node control circuit and a first write-in circuit; the driving circuit is configured to generate a driving current for driving the light-emitting element under the control of a potential at a driving node; the first write-in circuit is configured to write a first data voltage into a control node under the control of a write-in control signal; and the driving node control circuit is configured to control the driving node to be electrically coupled to or electrically decoupled from a first voltage end under the control of a potential at the control node.

### TECHNICAL FIELD

The present disclosure relates to the field of display technology, in particular to a pixel circuit, a driving method and a display device.

### BACKGROUND

With the coming of metaverse and the promotion of Augmented Reality (AR)/Virtual Reality (VR) technology, microdisplay has become a mainstream, and a silicon-based Organic Light-Emitting Diode (OLED)/Light-Emitting Diode (LED) display device is an essential component. An LED element is superior over an OLED element in terms of luminance and service life due to the use of an inorganic luminescent material as well as its optical-electrical characteristics.

### SUMMARY

In one aspect, the present disclosure provides in some embodiments a pixel circuit, including a light-emitting element, a driving circuit, a driving node control circuit and a first write-in circuit; a control end of the driving circuit is electrically coupled to a driving node, and the driving circuit is configured to generate a driving current for driving the light-emitting element under the control of a potential at the driving node; the first write-in circuit is electrically coupled to a write-in control line, a first data line and a control node, and configured to write a first data voltage provided by the first data line into the control node under the control of a write-in control signal provided by the write-in control line; and the driving node control circuit is electrically coupled to the control node, a first voltage end and the driving node, and configured to control the driving node to be electrically coupled to or electrically decoupled from the first voltage end under the control of a potential at the control node.

Optionally, the pixel circuit further includes an energy storage circuit, a second write-in circuit and a compensation control circuit; the energy storage circuit is electrically coupled to the driving node, and configured to store electric energy; a first end of the driving circuit is electrically coupled to a first node, and a second end of the driving circuit is electrically coupled to a second node; the second write-in circuit is electrically coupled to a scanning line, a second data line and the first node, and configured to control the second data line to write a second data voltage into the first node under the control of a scanning signal provided by the scanning line; and the compensation control circuit is electrically coupled to the scanning line, the driving node and the second node, and configured to control the driving node to be electrically coupled to or electrically decoupled from the second node under the control of the scanning signal.

Optionally, the pixel circuit further includes a first light-emission control circuit and a second light-emission control circuit; the first light-emission control circuit is electrically coupled to a first light-emission control end, a power source voltage end and the first node, and configured to control the power source voltage end to be electrically coupled to or electrically decoupled from the first node under the control of a first light-emission control signal provided by the first light-emission control end; the second light-emission control circuit is electrically coupled to a second light-emission control end, the second node and a first electrode of the light-emitting element, and configured to control the second node to be electrically coupled to or electrically decoupled from the first electrode of the light-emitting element under the control of a second light-emission control signal provided by the second light-emission control end; and a second electrode of the light-emitting element is electrically coupled to the first voltage end.

Optionally, the pixel circuit further includes a first initialization circuit; and the first initialization circuit is electrically coupled to an initial control end, an initial voltage end and the driving node, and configured to write an initial voltage provided by the initial voltage end into the driving node under the control of an initial control signal provided by the initial control end.

Optionally, the pixel circuit further includes a second initialization circuit; and the second initialization circuit is electrically coupled to an initial control end, an initial voltage end and the second node, and configured to write an initial voltage provided by the initial voltage end into the second node under the control of an initial control signal provided by the initial control end.

Optionally, the first write-in circuit includes a first transistor, and the driving node control circuit includes a second transistor; a gate electrode of the first transistor is electrically coupled to the write-in control line, a first electrode of the first transistor is electrically coupled to the first data line, and a second electrode of the first transistor is electrically coupled to the control node; and a gate electrode of the second transistor is electrically coupled to the control node, a first electrode of the second transistor is electrically coupled to the first voltage end, and a second electrode of the second transistor is electrically coupled to the driving node.

Optionally, the driving circuit includes a driving transistor; and a gate electrode of the driving transistor is electrically coupled to the driving node, a first electrode of the driving transistor is electrically coupled to the first node, a second electrode of the driving transistor is electrically coupled to the second node, and a substrate of the driving transistor is electrically coupled to the power source voltage end.

Optionally, the energy storage circuit includes a storage capacitor, the second write-in circuit includes a third transistor, and the compensation control circuit includes a fourth transistor; a first end of the storage capacitor is electrically coupled to the first node, and a second end of the storage capacitor is electrically coupled to the second node; a gate electrode of the third transistor is electrically coupled to the scanning line, a first electrode of the third transistor is electrically coupled to the second data line, and a second electrode of the third transistor is electrically coupled to the first node; and a gate electrode of the fourth transistor is electrically coupled to the scanning line, a first electrode of the fourth transistor is electrically coupled to the driving node, and a second electrode of the fourth transistor is electrically coupled to the second node.

Optionally, the first light-emission control circuit includes a fifth transistor, and the second light-emission control circuit includes a sixth transistor; a gate electrode of the fifth transistor is electrically coupled to the first light-emission control end, a first electrode of the fifth transistor is electrically coupled to the power source voltage end, and a second electrode of the fifth transistor is electrically coupled to the first node; and a gate electrode of the sixth transistor is electrically coupled to the second light-emission control end, a first electrode of the sixth transistor is electrically coupled to the second node, and a second electrode of the sixth transistor is electrically coupled to the first electrode of the light-emitting element.

Optionally, the first initialization circuit includes a seventh transistor; and a gate electrode of the seventh transistor is electrically coupled to the initial control end, a first electrode of the seventh transistor is electrically coupled to the initial voltage end, and a second electrode of the seventh transistor is electrically coupled to the driving node.

Optionally, the second initialization circuit includes an eighth transistor; and a gate electrode of the eighth transistor is electrically coupled to the initial control end, a first electrode of the eighth transistor is electrically coupled to the initial voltage end, and a second electrode of the eighth transistor is electrically coupled to the second node.

In another aspect, the present disclosure provides in some embodiments a driving method, applied to the above-mentioned pixel circuit, including: writing, by the first write-in circuit, the first data voltage into the control node under the control of the write-in control signal, and controlling, by the driving node control circuit, the driving node to be electrically coupled to or electrically decoupled from the first voltage end under the control of the potential at the control node.

Optionally, a first end of the driving circuit is electrically coupled to a first node, and a second end of the driving circuit is electrically coupled to a second node; and the driving method includes: in a case that the driving node control circuit controls the driving node to be electrically coupled to the first voltage end, controlling, by the driving circuit, the first node to be electrically decoupled from the second node under the control of the potential at the driving node.

Optionally, the pixel circuit further includes an energy storage circuit, a second write-in circuit, a compensation control circuit, a first light-emission control circuit, a second light-emission control circuit, a first initialization circuit and a second initialization circuit; a display period includes a threshold voltage reading stage, a light-emitting stage, a write-in stage and a selective light-emitting stage arranged sequentially; and the driving method includes: at the threshold voltage reading stage, writing, by the second write-in circuit, a second data voltage into the first node under the control of a scanning signal; and controlling, by the compensation control circuit, the driving node to be electrically coupled to the second node under the control of the scanning signal; at the light-emitting stage, controlling, by the first light-emission control circuit, a power source voltage end to be electrically coupled to the first node under the control of a first light-emission control signal; controlling, by the second light-emission control circuit, the second node to be electrically coupled to a first electrode of the light-emitting element under the control of a second light-emission control signal; and driving, by the driving circuit, the light-emitting element to emit light; at the write-in stage, writing, by the first write-in circuit, the first data voltage into the control node under the control of the write-in control signal; and controlling, by the driving node control circuit, the driving node to be electrically coupled to or electrically decoupled from the first voltage end under the control of the potential at the control node; and at the selective light-emitting stage, controlling, by the first light-emission control circuit, the power source voltage end to be electrically coupled to the first node under the control of the first light-emission control signal; controlling, by the second light-emission control circuit, the second node to be electrically coupled to the first electrode of the light-emitting element under the control of the second light-emission control signal; in a case that the driving node control circuit controls the driving node to be electrically coupled to the first voltage end at the write-in stage, enabling the first end of the driving circuit to be electrically decoupled from the second end of the driving circuit; and in a case that the driving node control circuit controls the driving node to be electrically decoupled from the first voltage end at the write-in stage, driving, by the driving circuit, the light-emitting element to emit light.

Optionally, the display period further includes a resetting stage arranged before the threshold voltage reading stage, and the driving method further includes: at the resetting stage, controlling, by the first light-emission control circuit, the power source voltage end to be electrically coupled to the first node under the control of the first light-emission control signal, writing, by the first initialization circuit, an initial voltage into the driving node under the control of an initial control signal, and writing, by the second initialization circuit, the initial voltage into the second node under the control of the initial control signal.

In yet another aspect, the present disclosure further provides in some embodiments a display device including the above-mentioned pixel circuit.

### BRIEF DESCRIPTION OF THE DRAWINGS

FIG. 1 is a schematic view showing a pixel circuit according to at least one embodiment of the present disclosure;

FIG. 2 is a schematic view showing the pixel circuit according to at least one embodiment of the present disclosure;

FIG. 3 is a schematic view showing the pixel circuit according to at least one embodiment of the present disclosure;

FIG. 4 is a schematic view showing the pixel circuit according to at least one embodiment of the present disclosure;

FIG. 5 is a sequence diagram of the pixel circuit in FIG. 4;

FIG. 6A is a schematic view showing an operating state of the pixel circuit in FIG. 4 at a resetting stage S1;

FIG. 6B is a schematic view showing the operating state of the pixel circuit in FIG. 4 at a threshold voltage reading stage S2;

FIG. 6C is a schematic view showing the operating state of the pixel circuit in FIG. 4 at a light-emitting stage S3;

FIG. 6D is a schematic view showing the operating state of the pixel circuit in FIG. 4 at a write-in stage S4;

FIG. 6E is a schematic view showing the operating state of the pixel circuit in FIG. 4 at a selective light-emitting stage S5;

FIG. 7 is a sequence diagram of the pixel circuit in FIG. 4; and

FIG. 8 is a sequence diagram of the pixel circuit in FIG. 4.

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

All transistors adopted in the embodiments of the present disclosure may be thin film transistors, field effect transistors or any other elements having an identical characteristic. In order to differentiate two electrodes other than a gate electrode from each other, one of the two electrodes is called as first electrode and the other is called as second electrode.

In actual use, in a case that the transistor is a thin film transistor or field effect transistor, the first electrode may be a drain electrode and the second electrode may be a source electrode, or the first electrode may be a source electrode and the second electrode may be a drain electrode.

In the related art, the design of a pixel circuit in a silicon-based LED display device reflects its quality. In a case that a voltage-type pixel circuit is used, due to a current-luminance characteristic of an inorganic LED element, i.e., in a case that a same voltage is applied to two ends of the light-emitting element, different luminance occurs because of a manufacture process of the LED. However, in a case that a same current applied to the LED, the luminance is identical. In addition, due to a back-gate effect of a silicon-based Metal-Oxide-Semiconductor (MOS) transistor (the transistor has different threshold voltages at different source-to-gate voltages) and a difference in the threshold voltage for a same wafer due to the manufacture process, there exist the following phenomena.
(1) For the voltage-type pixel circuit, the LED manufacture process is highly required, and it may provide a stable current to ensure same luminance at different positions.
(2) Due to the back-gate effect and the difference in the threshold voltage, different luminance is provided at a same current, so Mura occurs.
(3) After the LED element is miniaturized, the photoelectric efficiency decreases dramatically, and adjacent LEDs have different luminance at a same current in a case of low current density, so there is a large difference in the luminance of the pixels at a medium-and-low grayscale level, and Mura occurs.

Based on the above, the present disclosure provides in some embodiments a new silicon-based LED pixel circuit of a current-driven type, and it may compensate for the difference in the threshold voltage. With respect to a problem that micro LEDs have a large difference in luminance and chromaticity at a low current density, a pixel circuit structure with short-period light emission is used at a high current density, so as to provide a pixel driving circuit for a high-quality silicon-based LED display device.

In the related art, LED display is used for various display scenarios, and in a case that it is used in combination with a silicon substrate, due to a limited area of the silicon substrate, the LED display is mainly used for a 1.5-inch product or less. In addition, due to a high integration level and a small element, a characteristic of the silicon-based LED display is high Pixels Per Inch (PPI). In order to meet the requirement on high PPI, an LED light-emitting element needs to be small, and in a case of a smaller LED element, a defect thereof is more obviously, and the efficiency, the luminance and the chromaticity at a low current density may become worse. In the embodiments of the present disclosure, it is able to avoid a region where the LED characteristic is relatively poor at a low current density, and achieve various grayscale levels and a high-quality display effect through the short-period light-emission at a high current density.

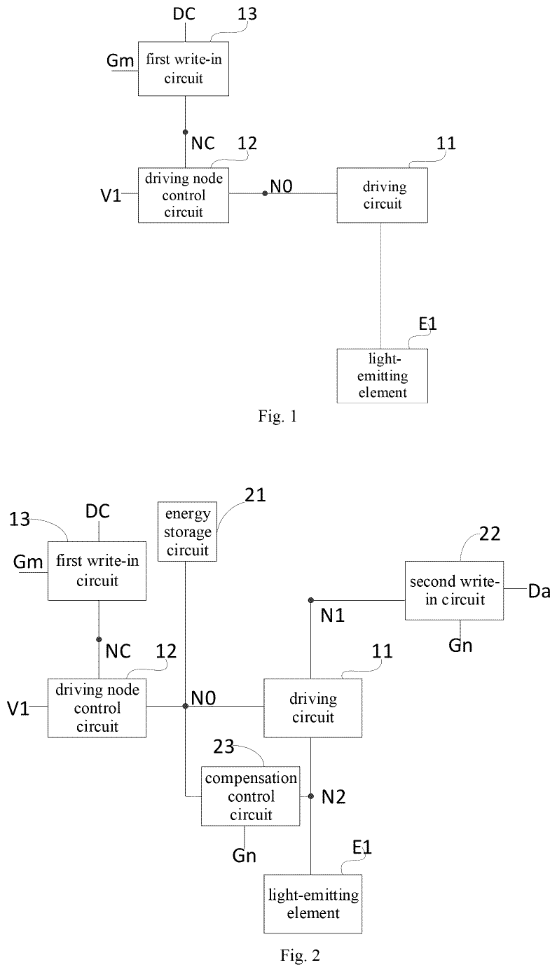

As shown in FIG. 1, the present disclosure provides in some embodiments a pixel circuit, which includes a light-emitting element E1, a driving circuit 11, a driving node control circuit 12 and a first write-in circuit 13; a control end of the driving circuit 11 is electrically coupled to a driving node N0, and the driving circuit 11 is configured to generate a driving current for driving the light-emitting element E1 under the control of a potential at the driving node N0; the first write-in circuit 13 is electrically coupled to a write-in control line Gm, a first data line DC and a control node NC, and configured to write a first data voltage provided by the first data line DC into the control node NC under the control of a write-in control signal provided by the write-in control line Gm; and the driving node control circuit 12 is electrically coupled to the control node NC, a first voltage end V1 and the driving node N0, and configured to control the driving node N0 to be electrically coupled to or electrically decoupled from the first voltage end V1 under the control of a potential at the control node NC.

According to the pixel circuit in the embodiments of the present disclosure, a light-emission duration control module consisting of the driving node control circuit 12 and the first write-in circuit 13 is added, so as to control an on-state duration of a driving transistor of the driving circuit 11 through the driving node control circuit 12 and the first write-in circuit 13, thereby to control the light-emission duration and adjust the luminance.

In the embodiments of the present disclosure, during the operation of the pixel circuit in FIG. 1, the first write-in circuit 13 writes a first data voltage Vdata1 into the control node NC under the control of the write-in control signal, and the driving node control circuit 12 controls the driving node N0 to be electrically coupled to or electrically decoupled from the first voltage end V1 under the control of the potential at the control node NC. In a case that the driving node N0 is electrically coupled to the first voltage end V1, the driving transistor is turned off; and in a case that the driving node N0 is electrically decoupled from the first voltage end V1, the driving transistor is turned on under the control of a potential at the control end.

In at least one embodiment of the present disclosure, the pixel circuit further includes an energy storage circuit, a second write-in circuit and a compensation control circuit; the energy storage circuit is electrically coupled to the driving node, and configured to store electric energy; a first end of the driving circuit is electrically coupled to a first node, and a second end of the driving circuit is electrically coupled to a second node; the second write-in circuit is electrically coupled to a scanning line, a second data line and the first node, and configured to control the second data line to write a second data voltage into the first node under the control of a scanning signal provided by the scanning line; and the compensation control circuit is electrically coupled to the scanning line, the driving node and the second node, and configured to control the driving node to be electrically coupled to or electrically decoupled from the second node under the control of the scanning signal.

During the implementation, the pixel circuit further includes the energy storage circuit, the second write-in circuit and the compensation control circuit. The energy storage circuit maintains the potential at the driving node, and the second write-in circuit controls the driving node to be electrically coupled to or electrically decoupled from the second node under the control of the scanning signal, so as to control the threshold voltage compensation.

As shown in FIG. 2, on the basis of the pixel circuit in FIG. 1, in at least one embodiment of the present disclosure, the pixel circuit further includes an energy storage circuit 21, a second data write-in circuit 22 and a compensation control circuit 23. The energy storage circuit 21 is electrically coupled to the driving node N0, and configured to store electric energy. The first end of the driving circuit 11 is electrically coupled to a first node N1, and the second end of the driving circuit 11 is electrically coupled to a second node N2. The second write-in circuit 22 is electrically coupled to a scanning line Gn, a second data line Da and the first node N1, and configured to control the second data line Da to write a second data voltage Vdata2 into the first node N1 under the control of a scanning signal provided by the scanning line Gn. The compensation control circuit 23 is electrically coupled to the scanning line Gn, the driving node N0 and the second node N2, and configured to control the driving node N0 to be electrically coupled to or electrically decoupled from the second node N2 under the control of the scanning signal.

In at least one embodiment of the present disclosure, the pixel circuit further includes a first light-emission control circuit and a second light-emission control circuit; the first light-emission control circuit is electrically coupled to a first light-emission control end, a power source voltage end and the first node, and configured to control the power source voltage end to be electrically coupled to or electrically decoupled from the first node under the control of a first light-emission control signal provided by the first light-emission control end; the second light-emission control circuit is electrically coupled to a second light-emission control end, the second node and a first electrode of the light-emitting element, and configured to control the second node to be electrically coupled to or electrically decoupled from the first electrode of the light-emitting element under the control of a second light-emission control signal provided by the second light-emission control end; and a second electrode of the light-emitting element is electrically coupled to the first voltage end.

During the implementation, the pixel circuit further includes the first light-emission control circuit and the second light-emission control circuit, the first light-emission control circuit controls the power source voltage end to be electrically coupled to or electrically decoupled from the first node under the control of the first light-emission control signal, and the second light-emission control circuit controls the second node to be electrically coupled to or electrically decoupled from the first electrode of the light-emitting element under the control of the second light-emission control signal, so as to perform the light-emission control.

In at least one embodiment of the present disclosure, the pixel circuit further includes a first initialization circuit; and the first initialization circuit is electrically coupled to an initial control end, an initial voltage end and the driving node, and configured to write an initial voltage provided by the initial voltage end into the driving node under the control of an initial control signal provided by the initial control end.

During the implementation, the pixel circuit further includes the first initialization circuit, and at an initialization stage, the first initialization circuit writes the initial voltage into the driving node under the control of the initial control signal, so that the driving transistor of the driving circuit is turned on at the beginning of a threshold voltage reading stage.

In at least one embodiment of the present disclosure, the pixel circuit further includes a second initialization circuit; and the second initialization circuit is electrically coupled to an initial control end, an initial voltage end and the second node, and configured to write an initial voltage provided by the initial voltage end into the second node under the control of an initial control signal provided by the initial control end.

During the implementation, the pixel circuit further includes the second initialization circuit, and the second initialization circuit writes the initial voltage into the second node under the control of the initial control signal, so as to initialize a potential at the second node.

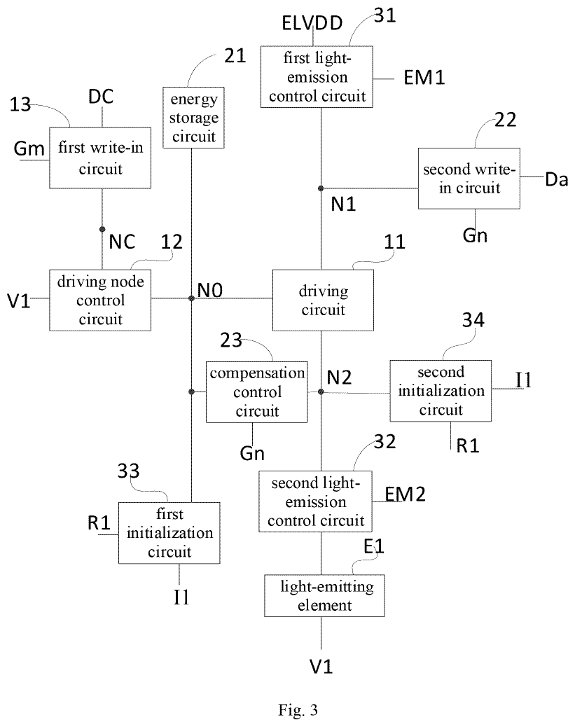

As shown in FIG. 3, on the basis of the pixel circuit in FIG. 2, in at least one embodiment of the present disclosure, the pixel circuit further includes a first light-emission control circuit 31, a second light-emission control circuit 32, a first initialization circuit 33 and a second initialization circuit 34.

The first light-emission control circuit 31 is electrically coupled to a first light-emission control end EM1, a power source voltage end ELVDD and the first node N1, and configured to control the power source voltage end ELVDD to be electrically coupled to or electrically decoupled from the first node N1 under the control of a first light-emission control signal provided by the first light-emission control end EM1.

The second light-emission control circuit 32 is electrically coupled to a second light-emission control end EM2, the second node N2 and a first electrode of the light-emitting element E1, and configured to control the second node N2 to be electrically coupled to or electrically decoupled from the first electrode of the light-emitting element E1 under the control of a second light-emission control signal provided by the second light-emission control end EM2. A second electrode of the light-emitting element E2 is electrically coupled to the first voltage end V1.

The first initialization circuit 33 is electrically coupled to an initial control end R1, an initial voltage end I1 and the driving node N0, and configured to write an initial voltage Vinit provided by the initial voltage end I1 into the driving node N0 under the control of an initial control signal provided by the initial control end R1.

The second initialization circuit 34 is electrically coupled to the initial control end R1, the initial voltage end I1 and the second node N2, and configured to write the initial voltage Vinit provided by the initial voltage end I1 into the second node N2 under the control of the initial control signal provided by the initial control end R1.

In at least one embodiment of the present disclosure, during the operation of the pixel circuit in FIG. 3, a display period includes a resetting state, a threshold voltage reading stage, a light-emitting stage, a write-in stage and a selective light-emitting stage arranged sequentially.

At the resetting stage, the first light-emission control circuit controls the power source voltage end to be electrically coupled to the first node under the control of the first light-emission control signal, the second initialization circuit writes the initial voltage into the driving node under the control of the initial control signal, and the second initialization circuit writes the initial voltage into the second node under the control of the initial control signal.

At the threshold voltage reading stage, the second write-in circuit writes the second data voltage into the first node under the control of the scanning signal, and the compensation control circuit controls the driving node to be electrically coupled to the second node under the control of the scanning signal.

At the light-emitting stage, the first light-emission control circuit controls the power source voltage end to be electrically coupled to the first node under the control of the first light-emission control signal, the second light-emission control circuit controls the second node to be electrically coupled to the first electrode of the light-emitting element under the control of the second light-emission control signal, and the driving circuit drives the light-emitting element to emit light.

At the write-in stage, the first write-in circuit writes the first data voltage into the control node under the control of the write-in control signal, and the driving node control circuit controls the driving node to be electrically coupled to or electrically decoupled from the first voltage end under the control of the potential at the control node.

At the selective light-emitting stage, the first light-emission control circuit controls the power source voltage end to be electrically coupled to the first node under the control of the first light-emission control signal; the second light-emission control circuit controls the second node to be electrically coupled to the first electrode of the light-emitting element under the control of the second light-emission control signal; in a case that the driving node control circuit controls the driving node to be electrically coupled to the first voltage end at the write-in stage, the first end of the driving circuit is electrically decoupled from the second end of the driving circuit; and in a case that the driving node control circuit controls the driving node to be electrically decoupled from the first voltage end at the write-in stage, the driving circuit drives the light-emitting element to emit light.

Optionally, the first write-in circuit includes a first transistor, and the driving node control circuit includes a second transistor; a gate electrode of the first transistor is electrically coupled to the write-in control line, a first electrode of the first transistor is electrically coupled to the first data line, and a second electrode of the first transistor is electrically coupled to the control node; and a gate electrode of the second transistor is electrically coupled to the control node, a first electrode of the second transistor is electrically coupled to the first voltage end, and a second electrode of the second transistor is electrically coupled to the driving node.

Optionally, the driving circuit includes a driving transistor; and a gate electrode of the driving transistor is electrically coupled to the driving node, a first electrode of the driving transistor is electrically coupled to the first node, a second electrode of the driving transistor is electrically coupled to the second node, and a substrate of the driving transistor is electrically coupled to the power source voltage end.

Optionally, the energy storage circuit includes a storage capacitor, the second write-in circuit includes a third transistor, and the compensation control circuit includes a fourth transistor; a first end of the storage capacitor is electrically coupled to the first node, and a second end of the storage capacitor is electrically coupled to the second node; a gate electrode of the third transistor is electrically coupled to the scanning line, a first electrode of the third transistor is electrically coupled to the second data line, and a second electrode of the third transistor is electrically coupled to the first node; and a gate electrode of the fourth transistor is electrically coupled to the scanning line, a first electrode of the fourth transistor is electrically coupled to the driving node, and a second electrode of the fourth transistor is electrically coupled to the second node.

Optionally, the first light-emission control circuit includes a fifth transistor, and the second light-emission control circuit includes a sixth transistor; a gate electrode of the fifth transistor is electrically coupled to the first light-emission control end, a first electrode of the fifth transistor is electrically coupled to the power source voltage end, and a second electrode of the fifth transistor is electrically coupled to the first node; and a gate electrode of the sixth transistor is electrically coupled to the second light-emission control end, a first electrode of the sixth transistor is electrically coupled to the second node, and a second electrode of the sixth transistor is electrically coupled to the first electrode of the light-emitting element.

Optionally, the first initialization circuit includes a seventh transistor; and a gate electrode of the seventh transistor is electrically coupled to the initial control end, a first electrode of the seventh transistor is electrically coupled to the initial voltage end, and a second electrode of the seventh transistor is electrically coupled to the driving node.

Optionally, the second initialization circuit includes an eighth transistor; and a gate electrode of the eighth transistor is electrically coupled to the initial control end, a first electrode of the eighth transistor is electrically coupled to the initial voltage end, and a second electrode of the eighth transistor is electrically coupled to the second node.

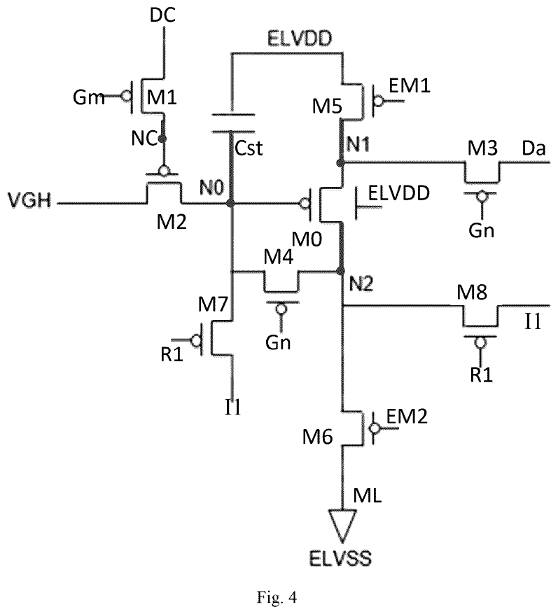

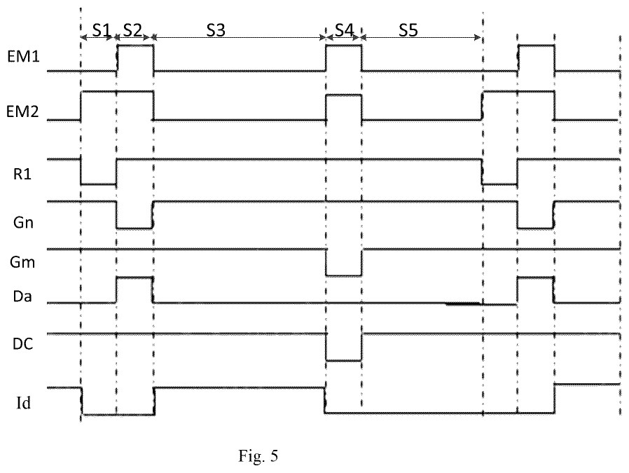

As shown in FIG. 4, on the basis of the pixel circuit in FIG. 3, in at least one embodiment of the present disclosure, the light-emitting element is a micro-LED ML, the first write-in circuit includes a first transistor M1, the driving node control circuit includes a second transistor M2, and a cathode of the micro-LED ML is electrically coupled to a low voltage end ELVSS. A gate electrode of the first transistor M1 is electrically coupled to the write-in control line Gm, a source electrode of the first transistor M1 is electrically coupled to the first data line DC, and a drain electrode of the first transistor M1 is electrically coupled to the control node NC. A gate electrode of the second transistor M2 is electrically coupled to the control node NC, a source electrode of the second transistor M2 is electrically coupled to a high voltage end VGH, and a drain electrode of the second transistor M2 is electrically coupled to the driving node N0.

The driving circuit includes a driving transistor M0. A gate electrode of the driving transistor M0 is electrically coupled to the driving node N0, a source electrode of the driving transistor M0 is electrically coupled to the first node N1, a drain electrode of the driving transistor M0 is electrically coupled to the second node N2, and a substrate of the driving transistor M0 is electrically coupled to a power source voltage end ELVDD.

The energy storage circuit includes a storage capacitor Cst, the second write-in circuit includes a third transistor M3, and the compensation control circuit includes a fourth transistor M4. A first end of the storage capacitor Cst is electrically coupled to the first node N1, and a second end of the storage capacitor Cst is electrically coupled to the second node N2. A gate electrode of the third transistor M3 is electrically coupled to the scanning line Gn, a source electrode of the third transistor M3 is electrically coupled to the second data line Da, and a drain electrode of the third transistor M3 is electrically coupled to the first node N1. A gate electrode of the fourth transistor M4 is electrically coupled to the scanning line Gn, a source electrode of the fourth transistor M4 is electrically coupled to the driving node N0, and a drain electrode of the fourth transistor M4 is electrically coupled to the second node N2.

The first light-emission control circuit includes a fifth transistor M5, and the second light-emission control circuit includes a sixth transistor M6. A gate electrode of the fifth transistor M5 is electrically coupled to the first light-emission control end EM1, a source electrode of the fifth transistor M5 is electrically coupled to the power source voltage end ELVDD, and a drain electrode of the fifth transistor M5 is electrically coupled to the first node N1. A gate electrode of the sixth transistor M6 is electrically coupled to the second light-emission control end EM2, a source electrode of the sixth transistor M6 is electrically coupled to the second node N2, and a drain electrode of the sixth transistor M6 is electrically coupled to an anode of the micro-LED ML.

The first initialization circuit includes a seventh transistor M7. A gate electrode of the seventh transistor M7 is electrically coupled to the initial control end R1, a source electrode of the seventh transistor M7 is electrically coupled to the initial voltage end I1, and a drain electrode of the seventh transistor M7 is electrically coupled to the driving node N0.

The second initialization circuit includes an eighth transistor M8. A gate electrode of the eighth transistor M8 is electrically coupled to the initial control end R1, a source electrode of the eighth transistor M8 is electrically coupled to the initial voltage end I1, and a drain electrode of the eighth transistor M8 is electrically coupled to the second node N2.

In FIG. 4, in at least one embodiment of the present disclosure, all the transistors are, but not limited to, p-type transistors.

In at least one embodiment of the present disclosure, M0 is a Double-diffused Metal-Oxide-Semiconductor (DMOS) transistor.

As shown in FIG. 5, in at least one embodiment of the present disclosure, during the operation of the pixel circuit in FIG. 4, a display period includes a resetting stage S1, a threshold voltage reading stage S2, a light-emitting stage S3, a write-in stage S4 and a selective light-emitting stage SS arranged sequentially.

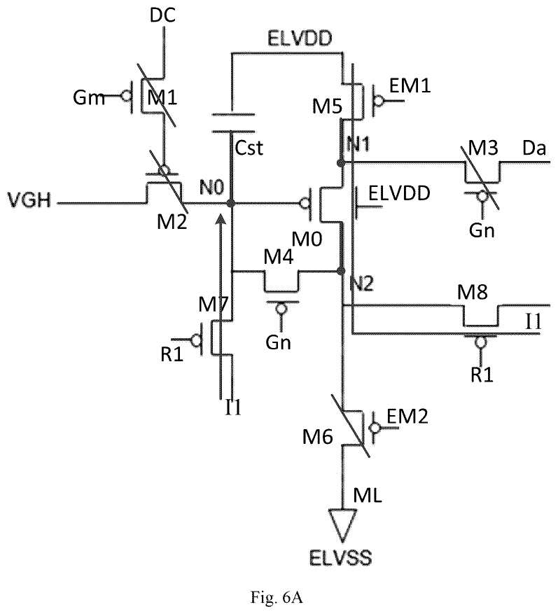

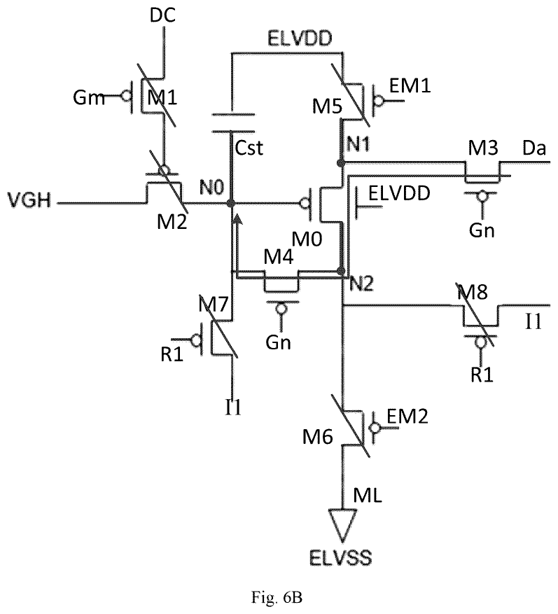

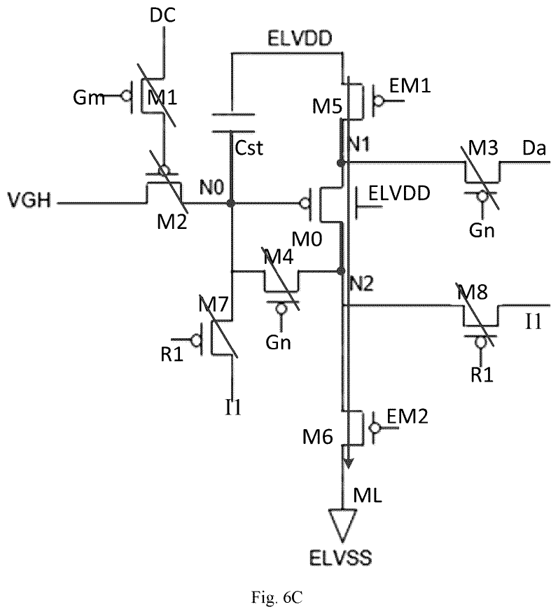

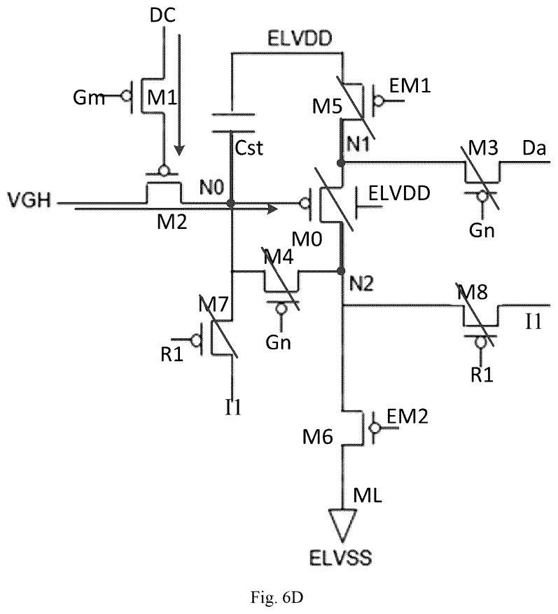

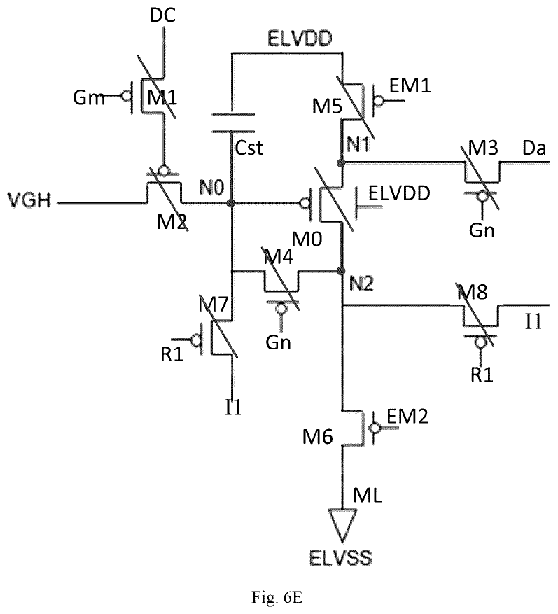

At the resetting stage S1, EM1 provides a low voltage signal, EM2 provides a high voltage signal, R1 provides a low voltage signal, Gn provides a high voltage signal, and Gm provides a high voltage signal. As shown in FIG. 6A, M5 is turned on, M8 is turned on, I1 provides the initial voltage Vinit, and M7 is turned on. At this time, a potential at the gate electrode of M0 is Vinit, a potential at the source electrode of M0 is Vdd, and a potential at the drain electrode of M0 is Vinit, so as to turn on M0 at the beginning of the threshold voltage reading stage S2 and initialize the potential at N1 and the potential at N2, where Vdd represents a voltage value of a power source voltage provided by ELVDD.

At the threshold voltage reading stage S2, EM1 provides a high voltage signal, EM2 provides a high voltage signal, R1 provides a high voltage signal, Gn provides a low voltage signal, and Gm provides a high voltage signal. At this time, a threshold voltage which has been read is a threshold voltage in a case that a data voltage is inputted and the back-gate effect occurs. As shown in FIG. 6B, M7, M5 and M8 are turned off, M3 and M4 are turned on, and N0 and N2 are short-circuited. At this time, D1 provides a second data voltage Vdata2.

At the beginning of the threshold voltage reading stage S2, M0 is turned on, Cst is charged by Vdata2 through M3, M0 and M4 which are turned on, until the potential VN0 at N0 is Vdata2+Vth−ef1, where Vth−ef1 represents a threshold voltage of M0 in a case that the back-gate effect occurs, and VN0 is Vdata+Vth−ef1. Vth−ef1=a(VB−Vdata2)+Vth, where Vth represents a threshold voltage of M0 in a case that no back-gate effect occurs, VB represents a voltage applied to the substrate of M0, VB=Vdd, a is a constant, i.e., a coefficient of the back-gate effect, and VN0=a(Vdd−Vdata2)+Vth.

At the light-emitting stage S3, EM1 and EM2 both provide a low voltage signal, R1 provides a high voltage signal, Gn provides a high voltage signal, and GM provides a high voltage signal. As shown in FIG. 6C, M5 and M6 are turned on, the potential at VN0 is maintained at a value at the threshold voltage reading stage S2 due to Cst, the potential at N1 is Vdd, Id=K*(Vgs−Vth)², where K is a current coefficient, Vgs is a gate-to-source voltage of M0, and Id=K*(a(Vdd−Vdata2)+Vth−Vdd−Vth)². At this time, a difference between the voltage applied to the substrate of M0 and a voltage at the gate electrode of M0 is 0, so the threshold voltage of M0 is Vth. Id=K(a*Vdd−Vdd−a*Vdata2)², so the voltage applied to M3 is merely related to Vdd and Vdata2, but irrelevant to the threshold voltage.

At the write-in stage S4, EM1 and EM2 both provide a high voltage signal, R1 and Gn both provide a high voltage signal, Gm provides a low voltage signal, and DC provides the first data voltage Vdata1. As shown in FIG. 6D, the write-in stage S4 is a stage where a signal indicating whether the light-emitting element emits light continuously or does not emit light is read. M1 is turned on, the potential at N0 is Vdata1, and the other transistors are all turned off. Taking a medium-and-low grayscale level as an example, Vdata1 is a low voltage signal. At this time, M2 is turned on, N0 is electrically coupled to VGH, and M0 is turned off, so no current is generated by the pixel circuit, and the light-emitting element does not emit light. In a case of a medium-and-high grayscale level, Vdata1 is a high voltage signal. At this time, M2 is turned off, N0 is electrically decoupled from VGH, and M0 is turned on under the control of the potential at its gate electrode.

At the selective light-emitting stage S5, EM1 and EM2 both provide a low voltage signal, R1 provides a high voltage signal, Gn provides a high voltage signal, and Gm provides a high voltage signal. As shown in FIG. 6E, M5 and M6 are turned on.

In a case that N0 is electrically coupled to VGH at the write-in stage, ML does not emit light at the selective light-emitting stage S5. In a case that N0 is electrically decoupled from VGH at the write-in stage S4, the potential at N0 is maintained at a voltage like that at the light-emitting stage S3, and ML continuously emit light using an original current.

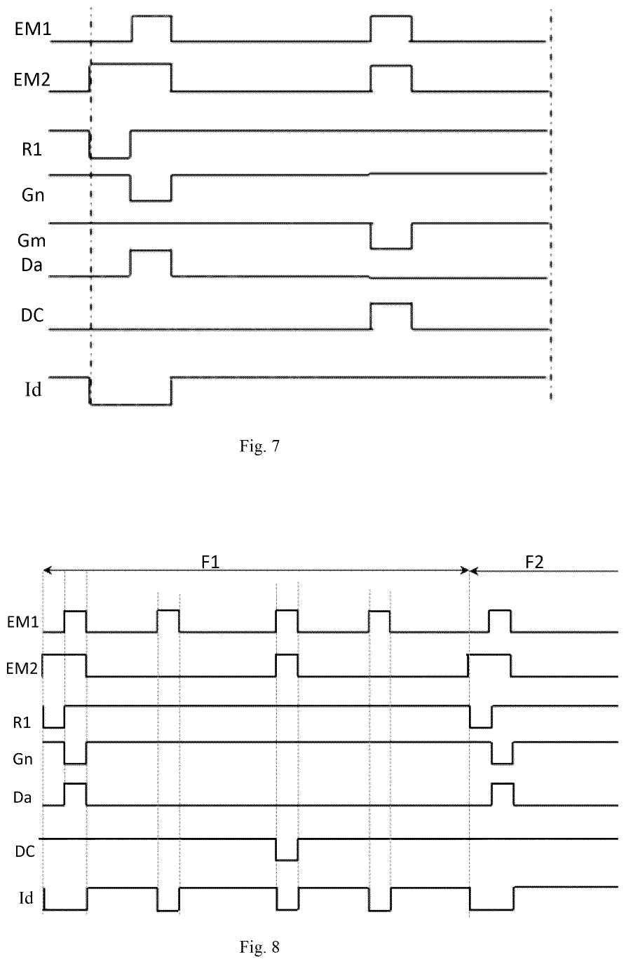

FIG. 5 is a sequence diagram of the control signals and the data voltages during the operation of the pixel circuit in FIG. 4 at a medium-and-low grayscale level. FIG. 7 is a sequence diagram of the control signals and the data voltages during the operation of the pixel circuit in FIG. 4 at a medium-and-high grayscale level.

In the related art, after the LED is miniaturized, a defect at a periphery of a light-emitting region becomes more obviously due to a process, e.g., etching, so the efficiency is deteriorated, and the defect, e.g., the poor brightness and unstable chromaticity at a low current density also becomes more obvious. In the embodiments of the present disclosure, it is able to prevent the occurrence of the defect for the micro-LED at a low current density. In a case that it is impossible to increase the efficiency of the micro-LED within a short time period, a light-emitting area of the LED may be reduced to increase a current density of the LED, so as to ensure that the LED is at a high efficiency region within more grayscale ranges. At this time, the light emission needs to be performed within a long time period, i.e., a duty ratio of the light-emission control signal needs to be adjusted, and a sequence where the duty ratios of the first light-emission control signal and the second light-emission control signal are adjusted may also be supported.

As shown in FIG. 8, during the operation of the pixel circuit in FIG. 4, in at least one embodiment of the present disclosure, in a case of a medium-and-high grayscale level, a duty ratio of EM1 is adjusted to control the luminance of ML.

In FIG. 7, F1 represents a first frame, and F2 represents a second frame.

In the embodiments of the present disclosure, a connection relationship of the substrate of M0 and the resetting of its source electrode are improved, so as to compensate for and cancel out a change in the threshold voltage caused by the back-gate effect.

In the related art, the back-gate effect refers to that the threshold voltage of the MOS transistor changes along with different potentials between its source electrode and the substrate.

The present disclosure further provides in some embodiments a driving method applied to the above-mentioned pixel circuit, which includes: writing, by the first write-in circuit, the first data voltage into the control node under the control of the write-in control signal, and controlling, by the driving node control circuit, the driving node to be electrically coupled to or electrically decoupled from the first voltage end under the control of the potential at the control node.

In at least one embodiment of the present disclosure, a first end of the driving circuit is electrically coupled to a first node, and a second end of the driving circuit is electrically coupled to a second node; and the driving method includes: in a case that the driving node control circuit controls the driving node to be electrically coupled to the first voltage end, controlling, by the driving circuit, the first node to be electrically decoupled from the second node under the control of the potential at the driving node.

In at least one embodiment of the present disclosure, the pixel circuit further includes an energy storage circuit, a second write-in circuit, a compensation control circuit, a first light-emission control circuit, a second light-emission control circuit, a first initialization circuit and a second initialization circuit; a display period includes a threshold voltage reading stage, a light-emitting stage, a write-in stage and a selective light-emitting stage arranged sequentially; and the driving method includes: at the threshold voltage reading stage, writing, by the second write-in circuit, a second data voltage into the first node under the control of a scanning signal; and controlling, by the compensation control circuit, the driving node to be electrically coupled to the second node under the control of the scanning signal; at the light-emitting stage, controlling, by the first light-emission control circuit, a power source voltage end to be electrically coupled to the first node under the control of a first light-emission control signal; controlling, by the second light-emission control circuit, the second node to be electrically coupled to a first electrode of the light-emitting element under the control of a second light-emission control signal; and driving, by the driving circuit, the light-emitting element to emit light; at the write-in stage, writing, by the first write-in circuit, the first data voltage into the control node under the control of the write-in control signal; and controlling, by the driving node control circuit, the driving node to be electrically coupled to or electrically decoupled from the first voltage end under the control of the potential at the control node; and at the selective light-emitting stage, controlling, by the first light-emission control circuit, the power source voltage end to be electrically coupled to the first node under the control of the first light-emission control signal; controlling, by the second light-emission control circuit, the second node to be electrically coupled to the first electrode of the light-emitting element under the control of the second light-emission control signal; in a case that the driving node control circuit controls the driving node to be electrically coupled to the first voltage end at the write-in stage, enabling the first end of the driving circuit to be electrically decoupled from the second end of the driving circuit; and in a case that the driving node control circuit controls the driving node to be electrically decoupled from the first voltage end at the write-in stage, driving, by the driving circuit, the light-emitting element to emit light.

In at least one embodiment of the present disclosure, the display period further includes a resetting stage arranged before the threshold voltage reading stage, and the driving method further includes: at the resetting stage, controlling, by the first light-emission control circuit, the power source voltage end to be electrically coupled to the first node under the control of the first light-emission control signal, writing, by the first initialization circuit, an initial voltage into the driving node under the control of an initial control signal, and writing, by the second initialization circuit, the initial voltage into the second node under the control of the initial control signal.

The present disclosure further provides in some embodiments a display device which includes the above-mentioned pixel circuit.

The above are merely the preferred embodiments of the present disclosure. A person skilled in the art may make further modifications and improvements without departing from the principle of the present disclosure, and these modifications and improvements shall also fall within the scope of the present disclosure.

1. A pixel circuit, comprising a light-emitting element, a driving circuit, a driving node control circuit and a first write-in circuit;
wherein a control end of the driving circuit is electrically coupled to a driving node, and the driving circuit is configured to generate a driving current for driving the light-emitting element under the control of a potential at the driving node;
the first write-in circuit is electrically coupled to a write-in control line, a first data line and a control node, and configured to write a first data voltage provided by the first data line into the control node under the control of a write-in control signal provided by the write-in control line; and
the driving node control circuit is electrically coupled to the control node, a first voltage end and the driving node, and configured to control the driving node to be electrically coupled to or electrically decoupled from the first voltage end under the control of a potential at the control node.

2. The pixel circuit according to claim 1, further comprising an energy storage circuit, a second write-in circuit and a compensation control circuit;
wherein the energy storage circuit is electrically coupled to the driving node, and configured to store electric energy;
a first end of the driving circuit is electrically coupled to a first node, and a second end of the driving circuit is electrically coupled to a second node;
the second write-in circuit is electrically coupled to a scanning line, a second data line and the first node, and configured to control the second data line to write a second data voltage into the first node under the control of a scanning signal provided by the scanning line; and
the compensation control circuit is electrically coupled to the scanning line, the driving node and the second node, and configured to control the driving node to be electrically coupled to or electrically decoupled from the second node under the control of the scanning signal.

3. The pixel circuit according to claim 2, further comprising a first light-emission control circuit and a second light-emission control circuit;
wherein the first light-emission control circuit is electrically coupled to a first light-emission control end, a power source voltage end and the first node, and configured to control the power source voltage end to be electrically coupled to or electrically decoupled from the first node under the control of a first light-emission control signal provided by the first light-emission control end;
the second light-emission control circuit is electrically coupled to a second light-emission control end, the second node and a first electrode of the light-emitting element, and configured to control the second node to be electrically coupled to or electrically decoupled from the first electrode of the light-emitting element under the control of a second light-emission control signal provided by the second light-emission control end; and
a second electrode of the light-emitting element is electrically coupled to the first voltage end.

4. The pixel circuit according to claim 1, further comprising a first initialization circuit;
wherein the first initialization circuit is electrically coupled to an initial control end, an initial voltage end and the driving node, and configured to write an initial voltage provided by the initial voltage end into the driving node under the control of an initial control signal provided by the initial control end.

5. The pixel circuit according to claim 2, further comprising a second initialization circuit;
wherein the second initialization circuit is electrically coupled to an initial control end, an initial voltage end and the second node, and configured to write an initial voltage provided by the initial voltage end into the second node under the control of an initial control signal provided by the initial control end.

6. The pixel circuit according to claim 1, wherein the first write-in circuit comprises a first transistor, and the driving node control circuit comprises a second transistor;
a gate electrode of the first transistor is electrically coupled to the write-in control line, a first electrode of the first transistor is electrically coupled to the first data line, and a second electrode of the first transistor is electrically coupled to the control node; and
a gate electrode of the second transistor is electrically coupled to the control node, a first electrode of the second transistor is electrically coupled to the first voltage end, and a second electrode of the second transistor is electrically coupled to the driving node.

7. The pixel circuit according to claim 1, wherein the driving circuit comprises a driving transistor; and
a gate electrode of the driving transistor is electrically coupled to the driving node, a first electrode of the driving transistor is electrically coupled to the first node, a second electrode of the driving transistor is electrically coupled to the second node, and a substrate of the driving transistor is electrically coupled to the power source voltage end.

8. The pixel circuit according to claim 2, wherein the energy storage circuit comprises a storage capacitor, the second write-in circuit comprises a third transistor, and the compensation control circuit comprises a fourth transistor;
a first end of the storage capacitor is electrically coupled to the first node, and a second end of the storage capacitor is electrically coupled to the second node;
a gate electrode of the third transistor is electrically coupled to the scanning line, a first electrode of the third transistor is electrically coupled to the second data line, and a second electrode of the third transistor is electrically coupled to the first node; and
a gate electrode of the fourth transistor is electrically coupled to the scanning line, a first electrode of the fourth transistor is electrically coupled to the driving node, and a second electrode of the fourth transistor is electrically coupled to the second node.

9. The pixel circuit according to claim 3, wherein the first light-emission control circuit comprises a fifth transistor, and the second light-emission control circuit comprises a sixth transistor;
a gate electrode of the fifth transistor is electrically coupled to the first light-emission control end, a first electrode of the fifth transistor is electrically coupled to the power source voltage end, and a second electrode of the fifth transistor is electrically coupled to the first node; and
a gate electrode of the sixth transistor is electrically coupled to the second light-emission control end, a first electrode of the sixth transistor is electrically coupled to the second node, and a second electrode of the sixth transistor is electrically coupled to the first electrode of the light-emitting element.

10. The pixel circuit according to claim 4, wherein the first initialization circuit comprises a seventh transistor; and
a gate electrode of the seventh transistor is electrically coupled to the initial control end, a first electrode of the seventh transistor is electrically coupled to the initial voltage end, and a second electrode of the seventh transistor is electrically coupled to the driving node.

11. The pixel circuit according to claim 5, wherein the second initialization circuit comprises an eighth transistor; and
a gate electrode of the eighth transistor is electrically coupled to the initial control end, a first electrode of the eighth transistor is electrically coupled to the initial voltage end, and a second electrode of the eighth transistor is electrically coupled to the second node.

12. A driving method, applied to the pixel circuit according to claim 1, comprising:
writing, by the first write-in circuit, the first data voltage into the control node under the control of the write-in control signal, and controlling, by the driving node control circuit, the driving node to be electrically coupled to or electrically decoupled from the first voltage end under the control of the potential at the control node.

13. The driving method according to claim 12, wherein a first end of the driving circuit is electrically coupled to a first node, and a second end of the driving circuit is electrically coupled to a second node; and the driving method comprises:
in a case that the driving node control circuit controls the driving node to be electrically coupled to the first voltage end, controlling, by the driving circuit, the first node to be electrically decoupled from the second node under the control of the potential at the driving node.

14. The driving method according to claim 13, wherein the pixel circuit further comprises an energy storage circuit, a second write-in circuit, a compensation control circuit, a first light-emission control circuit, a second light-emission control circuit, a first initialization circuit and a second initialization circuit; a display period comprises a threshold voltage reading stage, a light-emitting stage, a write-in stage and a selective light-emitting stage arranged sequentially; and the driving method comprises:
at the threshold voltage reading stage, writing, by the second write-in circuit, a second data voltage into the first node under the control of a scanning signal; and controlling, by the compensation control circuit, the driving node to be electrically coupled to the second node under the control of the scanning signal;
at the light-emitting stage, controlling, by the first light-emission control circuit, a power source voltage end to be electrically coupled to the first node under the control of a first light-emission control signal; controlling, by the second light-emission control circuit, the second node to be electrically coupled to a first electrode of the light-emitting element under the control of a second light-emission control signal; and driving, by the driving circuit, the light-emitting element to emit light;
at the write-in stage, writing, by the first write-in circuit, the first data voltage into the control node under the control of the write-in control signal; and controlling, by the driving node control circuit, the driving node to be electrically coupled to or electrically decoupled from the first voltage end under the control of the potential at the control node; and
at the selective light-emitting stage, controlling, by the first light-emission control circuit, the power source voltage end to be electrically coupled to the first node under the control of the first light-emission control signal; controlling, by the second light-emission control circuit, the second node to be electrically coupled to the first electrode of the light-emitting element under the control of the second light-emission control signal; in a case that the driving node control circuit controls the driving node to be electrically coupled to the first voltage end at the write-in stage, enabling the first end of the driving circuit to be electrically decoupled from the second end of the driving circuit; and in a case that the driving node control circuit controls the driving node to be electrically decoupled from the first voltage end at the write-in stage, driving, by the driving circuit, the light-emitting element to emit light.

15. The driving method according to claim 14, wherein the display period further comprises a resetting stage arranged before the threshold voltage reading stage, and the driving method further comprises:
at the resetting stage, controlling, by the first light-emission control circuit, the power source voltage end to be electrically coupled to the first node under the control of the first light-emission control signal, writing, by the first initialization circuit, an initial voltage into the driving node under the control of an initial control signal, and writing, by the second initialization circuit, the initial voltage into the second node under the control of the initial control signal.

16. A display device, comprising a pixel circuit according to claim 1.

17. The pixel circuit according to claim 2, wherein the first write-in circuit comprises a first transistor, and the driving node control circuit comprises a second transistor;
a gate electrode of the first transistor is electrically coupled to the write-in control line, a first electrode of the first transistor is electrically coupled to the first data line, and a second electrode of the first transistor is electrically coupled to the control node; and
a gate electrode of the second transistor is electrically coupled to the control node, a first electrode of the second transistor is electrically coupled to the first voltage end, and a second electrode of the second transistor is electrically coupled to the driving node.

18. The pixel circuit according to claim 3, wherein the first write-in circuit comprises a first transistor, and the driving node control circuit comprises a second transistor;
a gate electrode of the first transistor is electrically coupled to the write-in control line, a first electrode of the first transistor is electrically coupled to the first data line, and a second electrode of the first transistor is electrically coupled to the control node; and
a gate electrode of the second transistor is electrically coupled to the control node, a first electrode of the second transistor is electrically coupled to the first voltage end, and a second electrode of the second transistor is electrically coupled to the driving node.

19. The pixel circuit according to claim 4, wherein the first write-in circuit comprises a first transistor, and the driving node control circuit comprises a second transistor;
a gate electrode of the first transistor is electrically coupled to the write-in control line, a first electrode of the first transistor is electrically coupled to the first data line, and a second electrode of the first transistor is electrically coupled to the control node; and
a gate electrode of the second transistor is electrically coupled to the control node, a first electrode of the second transistor is electrically coupled to the first voltage end, and a second electrode of the second transistor is electrically coupled to the driving node.

20. The pixel circuit according to claim 5, wherein the first write-in circuit comprises a first transistor, and the driving node control circuit comprises a second transistor;
a gate electrode of the first transistor is electrically coupled to the write-in control line, a first electrode of the first transistor is electrically coupled to the first data line, and a second electrode of the first transistor is electrically coupled to the control node; and
a gate electrode of the second transistor is electrically coupled to the control node, a first electrode of the second transistor is electrically coupled to the first voltage end, and a second electrode of the second transistor is electrically coupled to the driving node.
